(19) United States
(12) Patent Application Publication
(10) Pub. No.: US 2016/0171539 A1
(43) Pub. Date: Jun. 16, 2016

(54) Inference-Based Behavioral Personalization and Targeting

(71) Applicant: Staples, Inc., Framingham, MA (US)

(72) Inventors: Chandrasekhar Ganduri, Grafton, MA (US); Anvesh Sati, Wayland, MA (US); Sreekanth Mahesala, Framingham, MA (US); Stephen Woundy, Framingham, MA (US); Begli Nursahedov, Waltham, MA (US); Vivek Kandhari, Hudson, MA (US); Stephen Zeek, Arlington, MA (US)

(21) Appl. No.: 14/687,908

(22) Filed: Apr. 15, 2015

Related U.S. Application Data
(60) Provisional application No. 62/091,415, filed on Dec. 12, 2014.

(51) Int. Cl. G06Q 30/02

(52) U.S. Cl. CPC G06Q 30/0255

(57) ABSTRACT

According to an example embodiment, a system is configured to determine a product group selectively grouping one or more of related products and related product classes; compute centroid values averaging customer preference values for the one or more of the related products and the related product classes of the product group; compute similarity scores between the product group and other product objects using the customer preference centroid values associated with the product group and customer preference values associated with the product objects; and select for recommendation one of the other product objects based on the similarity scores. The product objects including one or more of products and product classes from the product database.

### CROSS-REFERENCE TO RELATED APPLICATIONS

This application claims the benefit under 35 U.S.C. §119(e) of U.S. Provisional Application No. 62/091,415, entitled “Inference-Based Behavioral Personalization and Targeting”, filed on Dec. 12, 2014, the entire contents of which is incorporated herein by reference.

### BACKGROUND

The present disclosure relates to technology for, among other things, customer experience personalization and targeting using customer behavior. To better personalize customer experience and effectively target customers, it is important to understand and quantify a customer's relative preference for a product. However, existing solutions are limited to using primitive heuristics that inadequately predict user preferences. For instance, many solutions are unable to reliably predict other types of products a customer may be interested in based on the customer's browsing or purchasing habits, and instead are limited to recommending the same types of products that the customer has already purchased or shown interest in.

In other instances, many existing solutions heavily rely on previous data to target customers. However, in today's rapidly changing business environment with massive expansion of available products, the available data about previous customer interactions with “new” products is often sparse, causing these solutions to provide inadequate, inaccurate, or incomplete results. As a result, these solutions do not scale well due to the often sparse customer-product data set.

### SUMMARY

According to one innovative aspect of the subject matter described in this disclosure, a system includes one or more processors and one or more memories storing instructions that, when executed by the one or more processors, cause the system to, determine a product group selectively grouping one or more of related products and related product classes; compute centroid values averaging customer preference values for the one or more of the related products and the related product classes of the product group; compute similarity scores between the product group and other product objects using the customer preference centroid values associated with the product group and customer preference values associated with the product objects, the product objects including one or more of products and product classes from the product database; and select for recommendation one of the other product objects based on the similarity scores.

In general, another innovative aspect of the subject matter described in this disclosure may be embodied in methods that include determining a product group selectively grouping one or more of related products and related product classes; computing centroid values averaging customer preference values for the one or more of the related products and the related product classes of the product group; computing similarity scores between the product group and other product objects using the customer preference centroid values associated with the product group and customer preference values associated with the product objects, the product objects including one or more of products and product classes from the product database; and selecting for recommendation one of the other product objects based on the similarity scores.

Other aspects include corresponding methods, systems, apparatus, and computer program products for these and other innovative aspects.

These and other implementations may each optionally include one or more of the following features. For instance, the operations may further include: generating a customer-product preference matrix having a first dimension that includes the customers and a second dimension that includes the product group and the other product objects; populating a first set of entries corresponding to the customers and the other product objects in the customer-product preference matrix, the first set of entries reflecting the customer preference values of the customers for the other product objects; populating a second set of entries corresponding to the customers and the product group in the customer-product preference matrix, the second set of entries reflecting the customer preference centroid values of the customers for the product group; computing the similarity scores between the product group and the other product objects using the first set of entries and the second set of entries; storing in a non-transitory data store a product database including a plurality of products organized using product classes; receiving interaction data reflecting interactions by customers with instances of a shopping application associated with an online merchant, the interactions reflecting browsing or purchasing of different products from the product database by the customers; quantitatively determining the customer preference values, which indicate preferences of the customers for one or more of the products of the product database and the product classes to which the products of the product database belong; applying weights one or more dimensions of the set of dimensions; normalizing each of the weighted dimensions based on a predetermined scaling range; and computing the customer preference values using the normalized weighted dimensions.

For instance, the features may include that the interaction data includes a set of dimensions reflecting different aspects of behavior by customers when browsing and purchasing the different products; that the predetermined scaling range comprises one of a linear scaling and a sigmoidal scaling; and that the aspects include two or more of total visits to the shopping application by the customers, page view amounts for the different products, amounts of time spent on pages by the customers, products added to a virtual shopping cart of the shopping application, products removed from the virtual shopping cart of the shopping application, quantities or products ordered, unit prices of products ordered, and product returns.

According to yet another innovative aspect of the subject matter described in this disclosure, a system includes one or more processors and one or more memories storing instructions that, when executed by the one or more processors, cause the system to: determine similarity scores between a product group and other product classes using customer preference values associated with the product group and customer preference values associated with the product classes, the product group selectively grouping one or more of related products and related product classes; identify a set of top product classes from among the product classes based on the similarity scores associated with the product classes satisfying a predetermined threshold; compute a cumulative preference score for each of the customers, the cumulative preference score including the customer preference values for the product group and customer preference values associated with the top product classes; and determine a set of top customers from among the customers for a target product group based on the cumulative preference score of each of the customers, the target product group including one of the product group and one or more product classes from among the set of the top product classes.

In general, yet another innovative aspect of the subject matter described in this disclosure may be embodied in methods that include determining similarity scores between a product group and other product classes using customer preference values associated with the product group and customer preference values associated with the product classes, the product group selectively grouping one or more of related products and related product classes; identifying a set of top product classes from among the product classes based on the similarity scores associated with the product classes satisfying a predetermined threshold; computing a cumulative preference score for each of the customers, the cumulative preference score including the customer preference values for the product group and customer preference values associated with the top product classes; and determining a set of top customers from among the customers for a target product group based on the cumulative preference score of each of the customers, the target product group including one of the product group and one or more product classes from among the set of the top product classes.

In general, yet another innovative aspect of the subject matter described in this disclosure may be embodied in methods that include receiving interaction data reflecting interactions by customers with instances of a shopping application associated with an online merchant, the interactions reflecting browsing or purchasing of different products from a product database by the customers; quantitatively determining customer preference values indicating preferences of the customers for one or more of the products of the product database and the product classes to which the products of the product database belong; computing centroid values averaging the customer preference values for the one or more of the related products and the related product classes of a product group, the product group selectively grouping one or more of related products and related product classes; determining a first set of entries corresponding to the customers and the other product objects in a customer-product preference matrix, the first set of entries reflecting the customer preference values of the customers for the other product objects, the customer-product preference matrix having a first dimension that includes the customers and a second dimension that includes the product group and other product objects including one or more of products and product classes from the product database; determining a second set of entries corresponding to the customers and the product group in the customer-product preference matrix, the second set of entries reflecting the customer preference centroid values of the customers for the product group; computing the similarity scores between the product group and the other product objects using the first set of entries and the second set of entries; and selecting for recommendation one of the other product objects based on the similarity scores.

Other implementations of one or more of these aspects include corresponding systems, apparatus, and computer programs, configured to perform the actions of the methods, encoded on computer storage devices.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a diagram illustrating example customer-product interactions of customers with a product page describing a product

FIG. 2 is a graphical representation depicting graphs including results of two different example scoring methods.

FIGS. 3A and 3B are graphical representations depicting various examples of a customer-product preference matrix.

FIG. 4 is a graphical representation depicting an example mean score and customer size for an example base class and a combination of the base class and other example similar classes.

FIG. 5 is a block diagram of an example system for customer experience personalization and targeting using behavior.

FIG. 6 is a block diagram of an example computing system.

FIG. 7 depicts a flowchart of an example method for determining similar class(es).

FIGS. 8A and 8B depict a flowchart of a further example method for determining similar class(es).

FIG. 9 depicts a flowchart of an example method for determining top customers and/or classes for targeting.

### DETAILED DESCRIPTION

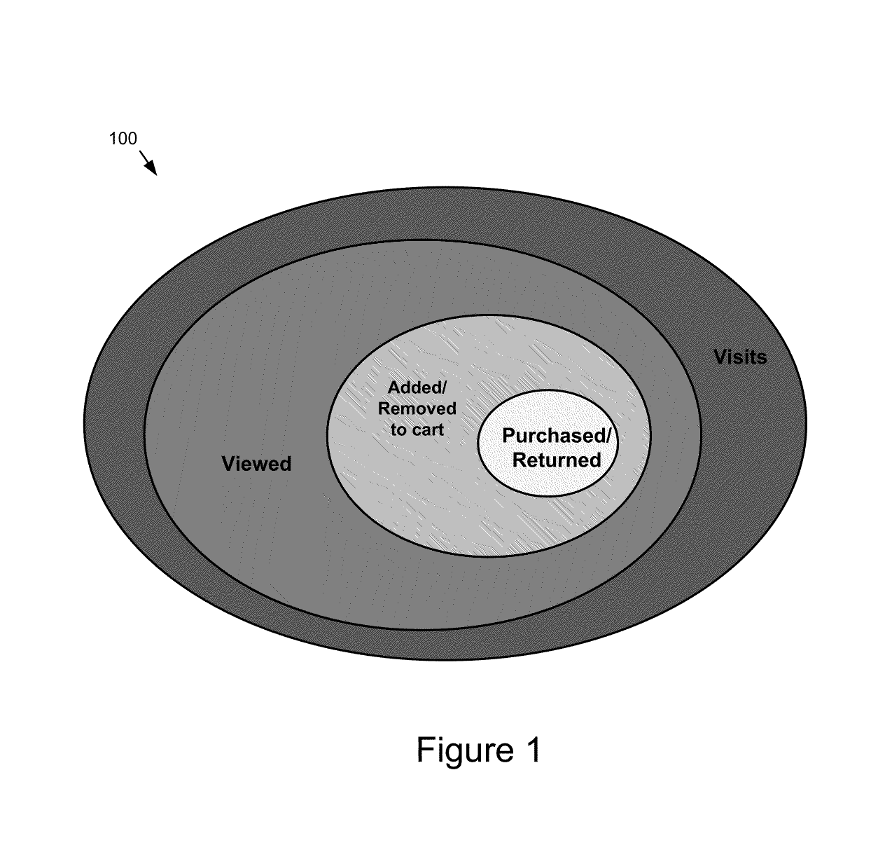

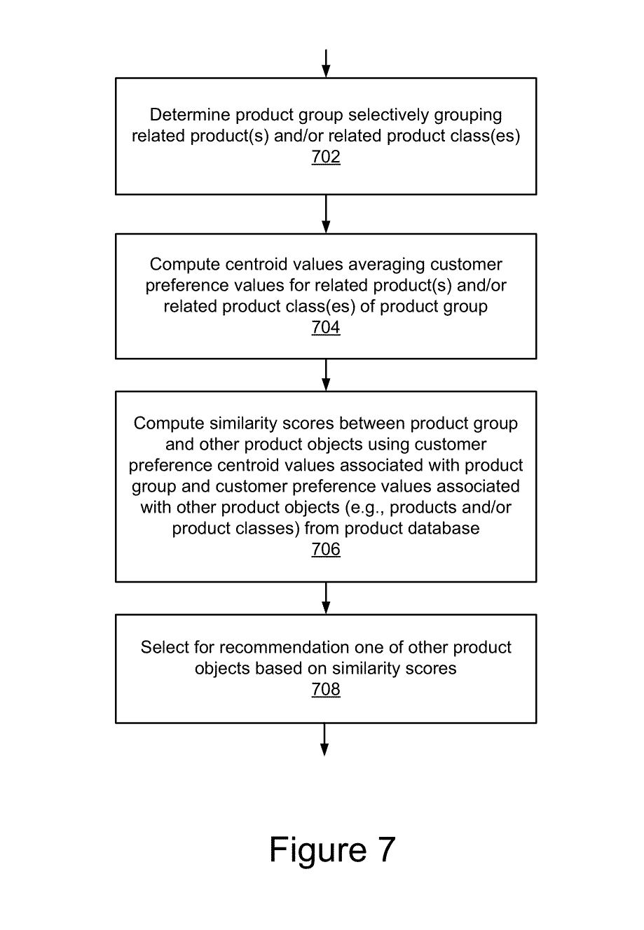

The technology disclosed herein includes various systems, methods, computer program products, interfaces, and other aspects to, for instance, more accurately interpret and quantify customer interactions, and as a result, more reliably predict user product preferences. Example customer-product interactions are described below in reference FIGS. 1 and 7, for example. User product preferences, such as a user preference for a particular product or product category, can be quantified as a score by the technology based on different customer behavioral elements. User product preferences are also discussed in further detail below. It is noted that combining the behavioral elements in a score is not a trivial problem. In some implementations, the score can be based on an application and a relevance of certain dimensions, which can be scaled and weighted to derive an overall preference score.

A high preference score for a given product can signal that the customer should be targeted for marketing efforts on that product to drive to a conversion. Two example applications of the preference score may include: choosing an accurate set of customers to target for a product and choosing an accurate set of products with which to target a customer. A valuable benefit of this approach can be that the preference scoring and the inferential structure can be used for targeting customers/products, new product offerings, promotional activities, and customer segmentation.

A customer may include an individual customer or a segment of customers sharing similar attributes. Revenue generated from a sale of a product can be computed from a unit price of the product and a quantity/number of units of the product purchased by the customer. In some implementations, the unit price can be fixed regardless of the quantity/number of units of the product purchased. In some implementations, the unit price can be discounted based on the quantity/number of units purchased by the customer.

An example method discussed herein can leverage customer behavior of existing products to infer the customer's potential/preference for “new” products. In a further example, the technology can make inferences about customer's preference for similar products, which it can determine based on distance in the customer-product preference vector space (e.g. customer-product preference matrix). This can be accomplished by a mechanism for quantifying customers' customer preference centroid values which averages the customers' preferences for product categories of a product group. The customers' customer preference centroids can be used for computing similarity scores between the customers' customer preference centroids and additional product categories in a customer-product preference matrix using cosine similarity, for instance.

Example benefits of the technology include but are not limited to providing for convenient targeting of potential customers even in light of the rapid expansion of a product assortment approaching an endless aisle; allowing for personalization and targeting of customers based on inferences from browsing behavior; identifying the relative preference of a customer to a product; quantifying the preferences allowing for identification of most preferred to least preferred products; extending the target set of customers by identifying similar products based on a similarity determination; providing a flexible approach that can be applied at any customer/customer segment level to target for any level in a product hierarchy; being domain agnostic; being suitable for use in numerous different applications including e-commerce, retail, and other industries; etc.

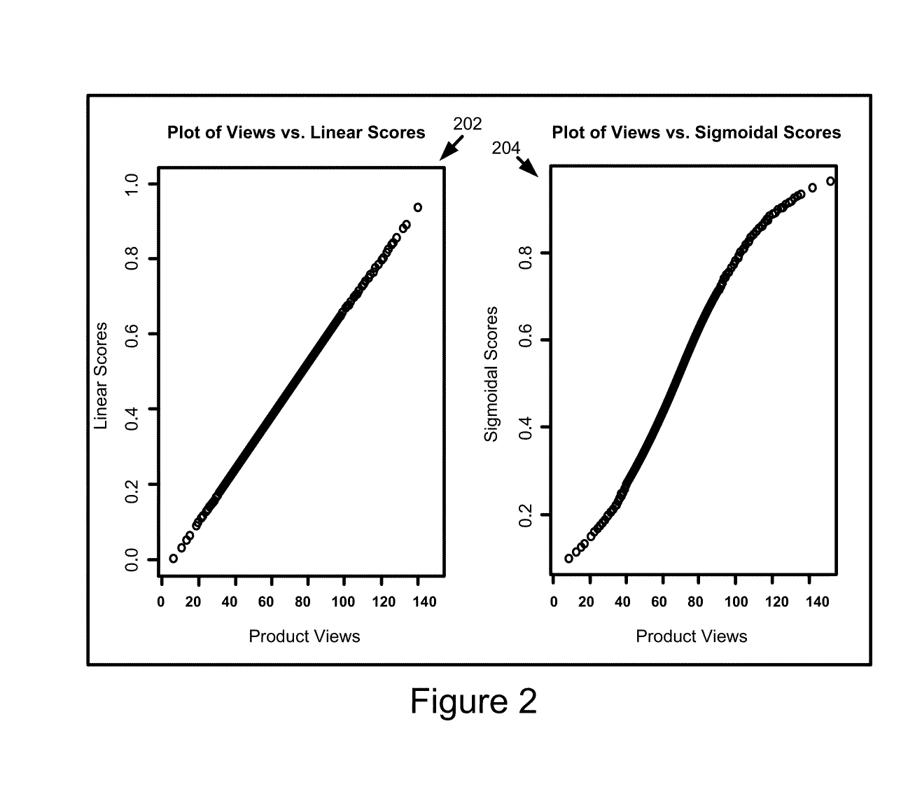

FIGS. 2-4 are graphical representations associated with example scoring methods and an example customer-product preference matrix, and are described in further detail below.

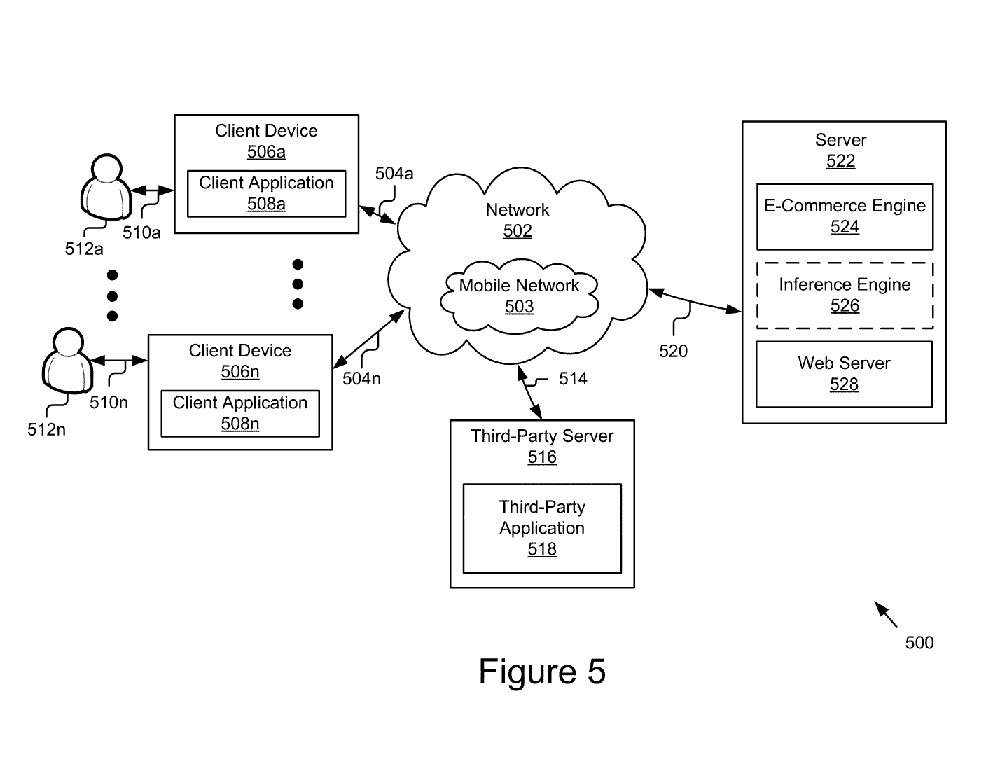

FIG. 5 is a block diagram of an example system 500 for providing the features and advantages discussed herein. The example system 500 includes a server 522, a third-party server 516, client device 506a . . . 506n (also referred to herein individually and/or collectively as 506) that are accessed by users 512a . . . 512n (also referred to herein individually and collectively as 512).

In the illustrated implementations, these entities are electronically communicatively coupled via a network 502 for interaction with one another, although other system configurations are possible including other devices, systems, and networks. For example, the system 500 may include any number of client devices 506, third-party servers 516, servers 522, and other systems and devices. While only one network 502 is coupled to the server 522, the third-party server 516, and the client devices 506a . . . 506n, in practice any number of networks 502 can be connected to these entities.

The network 502 may include any number of networks and/or network types. For example, the network 502 may include, but is not limited to, one or more local area networks (LANs), wide area networks (WANs) (e.g., the Internet), virtual private networks (VPNs), wireless wide area network (WWANs), WiMAX® networks, personal area networks (PANs) (e.g., Bluetooth® communication networks), a mobile (cellular) network 503 for wireless communication via, for example, GSM, LTE, HSDPA, WiMAX®, etc., a combination of the foregoing, etc.

The client device 506 may include one or more computing devices having data processing and communication capabilities. The client devices 506a and 506n, and their components, may be coupled to the network 502 via signal lines 504a and 504n. In some implementations, a client device 506 may include a processor (e.g., virtual, physical, etc.), a memory, a power source, a communication unit, and/or other software and/or hardware components, such as a display, graphics processor, wireless transceivers, keyboard, camera, sensors, firmware, operating systems, drivers, various physical connection interfaces (e.g., USB, HDMI, etc.). The client device 506 may couple to and communicate with other client devices 506 and the other entities of the system 500 via the network 502 using a wireless and/or wired connection.

Examples of client devices 506 may include, but are not limited to, mobile phones, tablets, laptops, desktops, netbooks, server appliances, servers, virtual machines, TVs, set-top boxes, media streaming devices, portable media players, navigation devices, personal digital assistants, etc. While two client devices 506a and 506n are depicted in FIG. 5, the system 500 may include any number of client devices 506. In addition, the client devices 506 may be the same or different types of computing devices. The client devices 506 include the capability of communicating with the server 522 via the network 502.

The client devices 506 may store and/or operate software such as a client application 508 (the instances of the client application 508a . . . 508n may be referred to herein independently and/or collectively as 508), operating system, other applications, etc. The client application 508 is configured to interact and exchange data with the server 522 via the network 502.

A plurality of client devices 506a . . . 506n are depicted in FIG. 5 to indicate that the server 522 and its components can aggregate information about and provide responses to a multiplicity of users 512a . . . 512n on a multiplicity of client devices 506a . . . 506n. In some implementations, a single user can use more than one client device 506, which the server 522 may track and aggregate interaction data associated with the user. In some implementations, the server 522 compiles and aggregates interaction data associated with the user during an advertising campaign associated with an online merchant's online shopping application. The advertising campaign may include a promotion period assigned by an online merchant for one or more products on a shopping application associated with an online merchant. In some implementations, the server 522 transmits the interaction data associated with the user to the inference engine 526 to perform its acts and/or functions as discussed elsewhere herein.

The server 522 is a computing device or system for customer experience personalization and targeting using behavior. In the depicted implementation, the server 522 is coupled to the network 502 via signal line 520. The server 522 may include one or more computing devices having data processing, storing, and communication capabilities. For example, the server 522 may include one or more hardware servers, server arrays, storage devices and/or systems, etc. The server 522 may include one or more virtual servers (e.g., virtual machines) implemented via software. For example, the virtual server operates in a host server environment and accesses the physical hardware of the host server including, for example, a processor, memory, storage, network interfaces, etc., via an abstraction layer (e.g., a virtual machine manager). It should be understood that the server 522 can be made up of any combination of devices and servers, or only one of device or server. The server 522 may interact with the other entities 506a . . . 506n and/or 516 of the system 500 via the network 502 or may be coupled to and interact with these entities via a direct data connection.

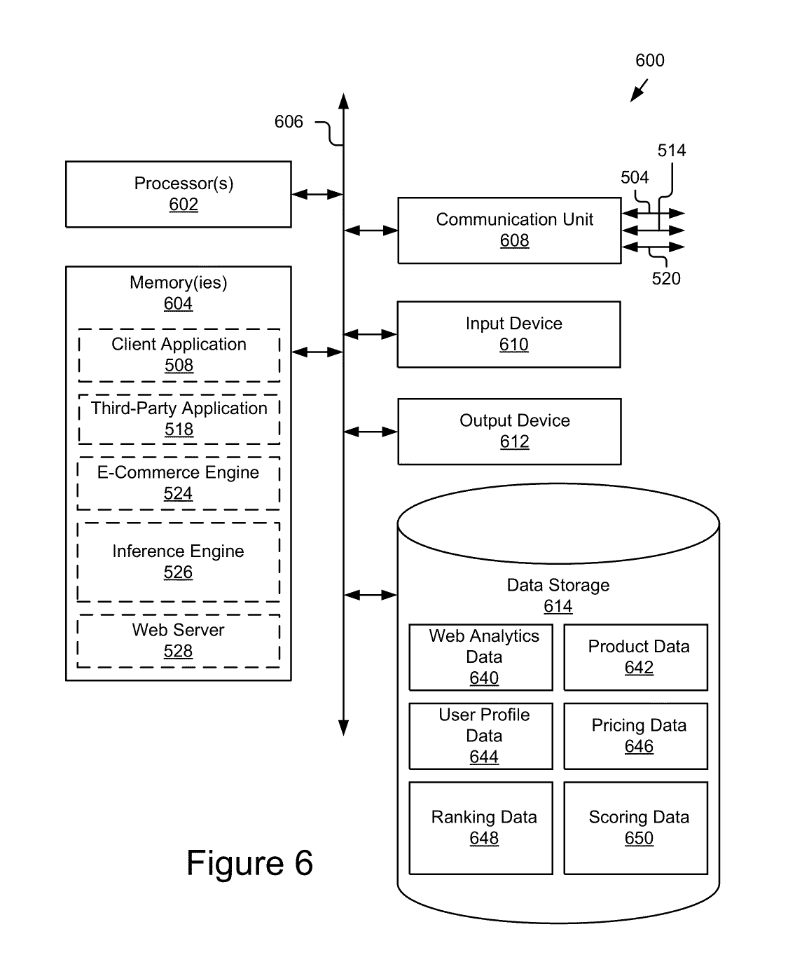

In FIG. 5, the server 522 includes an e-commerce engine 524, the inference engine 526, and a web server 528. The e-commerce engine 524 is software including routines for providing an e-commerce service/marketplace for various products and, storing and providing access to product information in a data store, such as the data storage 614 (see FIG. 6). The inference engine 526 is software including routines for performing the acts and functions discussed throughout this disclosure. In some implementations, the inference engine 526 is coupled to and interacts with the web server 528 and the e-commerce engine 524 to perform various acts and functionality. The web server 528 is software including routines for receiving and responding to content requests from the client devices 506 via the network 502.

The third-party server 516 may include one or more computing devices having data processing, storing, and communication capabilities. For example, the third-party server 516 may include one or more hardware servers, server arrays, storage devices and/or systems, etc. In some implementations, the third-party server 516 may include one or more virtual servers, which operate in a host server environment and access the physical hardware of the host server including, for example, a processor, memory, storage, network interfaces, etc., via an abstraction layer (e.g., a virtual machine manager). In some implementations, the third-party server 516 may include a web server (not shown) for processing content requests, such as an HTTP server, a REST (representational state transfer) service, or other server type, having structure and/or functionality for satisfying content requests and receiving content from one or more computing devices that are coupled to the network 502 (e.g., the client device 506, etc.). The third-party server 516 and its components may be coupled to the network 502 via signal line 514.

In the depicted implementation, the third-party server 516 hosts services such as a third-party application 518, which may be individual and/or incorporated into the services provided by the server 522. In some implementations, the third-party application 518 provides additional acts and/or information such as browsing history, tracking information, profile data, shopping data, etc. as further described in reference to FIG. 6. In some implementations, data provided by the third-party application 518 may alternatively and/or additionally be stored in and retrieved from data sources associated with the server 522, such as the data storage 614 (see FIG. 6).

It should be understood that the system 500 illustrated in FIG. 5 is representative of an example system for customer experience personalization and targeting using behavior and that a variety of different system environments and configurations are contemplated and are within the scope of the present disclosure. For instance, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Further, various entities of the system may be integrated into a single computing device or system or additional computing devices or systems, etc.

FIG. 6 is a block diagram of an example computing system 600. The example computing system 600 may represent the computer architecture of a client device 506, a third-party server 516, and/or a server 522, depending on the implementation. As depicted, the computing system 600 may include a processor(s) 602, a memory(ies) 604, a communication unit 608, an input device 610, an output device 612, and a data storage 614, which may be communicatively coupled by a communication bus 606. The computing system 600 depicted in FIG. 6 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 600 may include various operating systems, sensors, additional processors, and other physical configurations.

The processor(s) 602 may execute software instructions by performing various inputs, logical, and/or mathematical operations. The processor(s) 602 may use various different known computing architectures (e.g., embedded, micro-computer, workstation, mainframe, etc.) and instruction sets (e.g., ARM, RISC, x86, etc.), to process data signals. The processor(s) 602 may be physical and/or virtual, and may include a single core or plurality of processing units and/or cores. The processor(s) 602 may be coupled to the memory(ies) 604 via the bus 606 to access data and instructions therefrom and store data therein. The bus 606 may couple the processor 602 to the other components of the server 522 including, for example, the memory(ies) 604, the communication unit 608, the input device 610, the output device 612, and the data storage 614.

The memory(ies) 604 may include one or more non-transitory computer-usable (e.g., readable, writeable, etc.) media, which can be any non-transitory apparatus or device that can contain, store, communicate, propagate or transport instructions, data, computer programs, software, code, routines, etc., for processing by or in connection with the processor(s) 602. Non-limiting examples of the memory(ies) 604 include volatile memory and non-volatile memory, such as but not limited to a dynamic random access memory (DRAM) device, a static random access memory (SRAM) device, a discrete memory device (e.g., a PROM, FPROM, ROM), a hard disk drive, an optical disk drive (CD, DVD, Blue-ray™, etc.). It should be understood that the memory(ies) 604 may be a single device or may include multiple types of devices and configurations.

The memory(ies) 604 may store and provide access to data to the other components of the computing system 600. The memory(ies) 604 may be included in a single computing device or a plurality of computing devices. In some implementations, the memory(ies) 604 may store instructions and/or data that may be executed by the processor(s) 602. As depicted in FIG. 6, the memory(ies) 604 may store one or more of the client application 508, the third-party application 518, the e-commerce engine 524, the inference engine 526, the web server 528, and their respective components, depending on the configuration. The memory(ies) 604 is also capable of storing other instructions and data, including, for example, an operating system, hardware drivers, other software applications, databases, etc. The memory(ies) 604 may be coupled to the bus 606 for communication with the processor(s) 602 and the other components of computing system 600.

The bus 606 may include a communication bus for transferring data between components of a computing device or between computing devices, a network bus system including the network 502 or portions thereof, a processor mesh, a combination thereof, etc. In some implementations, the inference engine 526, the e-commerce engine 524, the web server 528, and various other components operating on the server 522 (operating systems, device drivers, etc.) may cooperate and communicate via a communication mechanism included in or implemented in association with the bus 606. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 608 may include one or more interface devices (I/F) for wired and wireless connectivity with the network 502 and the other components of the system 500, for example, the client device 506, the third-party server 516, the server 522, etc. For instance, the communication unit 608 may include, but is not limited to, CAT-type interfaces; wireless transceivers for sending and receiving signals using Wi-Fi™; Bluetooth®, IrDA™, Z-Wave™, ZigBee®, cellular communications, etc.; USB interfaces; various combinations thereof; etc. The communication unit 608 may include radio transceivers (5G, 4G, 3G, 2G, etc.) for communication with the network 502 and/or the mobile network 503, and radio transceivers for Wi-Fi™ and close-proximity/personal area (e.g., Bluetooth®, NFC, etc.) connectivity, geo-location transceivers (e.g., GPS) for receiving and providing location information for the corresponding device, and the like. The communication unit 608 may be coupled to the other components of the computing system 600 via the bus 606. The communication unit 608 may be coupled to the network 502 as illustrated by the signal lines 504, 514, or 520, depending on the configuration. In some implementations, the communication unit 608 can link the processor 602 to the network 502, which may in turn be coupled to other processing systems. The communication unit 608 can provide other connections to the network 502 and to other entities of the system 500 using various standard communication protocols, including, for example, those discussed elsewhere herein.

The input device 610 may include any device for inputting information into the computing system 600. In some implementations, the input device 610 may include one or more peripheral devices. For example, the input device 610 may include a keyboard (e.g., a QWERTY keyboard), a pointing device (e.g., a mouse or touchpad), microphone, an image/video capture device (e.g., camera), etc. In some implementations, the input devices 614 may include a touch-screen display capable of receiving input from the one or more fingers of the user. For instance, the structure and/or functionality of one or more of the input device 610 and the output device 612 may be integrated, and a user of the computing system 600 may interact with the computing system 600 by contacting a surface of a display (e.g., an output device 612) using one or more fingers. In this example, the user could interact with an emulated (e.g., virtual or soft) keyboard displayed on a touch-screen output device 612 by using fingers to contact the display in the keyboard regions.

The output device 612 may be any device capable of outputting information from the computing system 600. The output device 612 may include one or more of a display, a printer, a 3D printer, a haptic device, audio reproduction device, etc. In some implementations, the output device is a display which may display electronic images and data output by the computing system 600 for presentation to a user 506. The output device 612 may include any conventional display device, monitor or screen, including, for example, an organic light-emitting diode (OLED) display, a liquid crystal display (LCD), etc. In some implementations, the output device 612 may include a touch-screen display capable of receiving input from one or more fingers of a user 512. In some implementations, the computing system 600 may include an integrated or discrete graphics adapter (not shown) for rendering and outputting the images and data for presentation on output device 612.

The data storage 614 is an information source for storing and providing access to data. The data stored by the data storage 614 may organized and queried using various criteria including any type of data stored by them, such as a customer identifier, IP address, rewards account number, product identifier, product name, where products were purchased from, etc. The data storage 614 may include data tables, databases, or other organized collections of data. Examples of the types of data stored by the data storage 614 may include, but are not limited to, web analytics data 640, product data 642, user profile data 644, pricing data 646, ranking data 648, scoring data 650, etc., discussed elsewhere herein.

Web analytics data 640 may include data that can be learned from user interactions on computing devices 506 coupled via the network 502 with the server 522, the third-party server 516, and/or any other components of the system 500. The web analytics data 640 may include past behavior data describing the past actions of a customer, such as accessing, entering, interacting with, and leaving interfaces associated with the services provided by the server 522, the third-party server 516, and/or other components of the system. For example, the web analytics data 640 may include, but not limited to, the clickstream of a user/customer, the browsing history associated with a product or class of products visited by a user, etc., which can be used by the inference engine 526, as discussed elsewhere herein.

The web analytics data 640 may be aggregated from one or more information sources by the server 522. Information sources may include data storage 614, the third-party server 516, or other computing and/or storage components of the system 500. For example, the information sources may store and provide web analytics data such as web server access logs, user application usage logs, cookies, any real-time interaction data acquired by client and/or server-side modules (e.g., received from a client-side user tracking module, such as a tracking module implemented using JavaScript, a server log, etc.) in real-time or near real-time associated with the current or recent actions of a customer in association with an interface (e.g., user's identity and/or current on-site or in-app behavior, such as referrer, selections, items in cart, path, elements clicked, information typed, items hovered over, searches made, etc.). In some implementations, the web analytics data may include timestamps associated with each action taken by the users when interacting with the application interfaces, as well as user identifiers associated with the users and/or the client devices 506 of the users 512. Non-limiting examples of user identifiers include a user name, a unique ID, an IP address, a MAC address, or the like.

The web analytics data 640 may be accessible (e.g., searchable, readable, modifiable, etc.) by other components of the system 500. In some implementations, the third-party application 518, the e-commerce engine 524, the inference engine 526, the web server 528, etc., may access the web analytics data 640. For example, the client application 508 and/or the web server 528 may track user interactions/behavior on the client device 506 and store the user interactions as web analytics data 640. In another example, the inference engine 526 may analyze the attributes stored in the web analytics data 640 to determine additional attributes of a user or class of users, such as but not limited to, their likelihood to be affected by a certain discount in price on a product for sale using the e-commerce engine 524.

The web analytics data 640 may include data pertaining to the conversion of potential sales to completed sales. The web analytics data 640 may reflect each step of a typical sales funnel for each product. For instance, for a given product, the web analytics data 640 associated with that product may describe the number of users who viewed an interface featuring that product for sale, the number of users that added the product to a virtual shopping cart responsive to receiving a discount, the number of users that began the checkout process, the number of users that did or did not complete the checkout process, or any other dimension, such as those discussed elsewhere herein. The web analytics data 640 may be linked to other types of data in the data storage 614, for example 642, 644, 646, 648, 650, etc.

Product data 642 may include data and attributes concerning one or more products. Non-limiting examples of products includes office supplies, electronics, furniture, consumables, clothing, and/or any other consumer or business products. The product data 642 includes a plurality of product records respectively describing products available via the e-commerce engine 524. Each product record may describe the various aspects of the products. Each record may include one or more product attributes characterizing the product. Each record may also include unique product identifiers, names, descriptions, manufacturer info, specifications, photos, videos, reviews, ratings, etc. for products. The product data also includes product classifications and product hierarchies as discussed elsewhere herein.

The product data 642 may be linked with the other data such as the web analytics data 640, the user profile data 644, the pricing data 646, the ranking data 648, and the scoring data 650.

The user profile data 644 may include profiles for each of the users 512 of the system 500. A given user's profile may include the user's user account and attributes describing the user. The user account may include information associated with the user's identity on the services provided by the server 522, such as a username, password, preference data, payment information, etc. The attributes may characterize the user's preferences and/or identity. User attributes may be based on information provided by the user or information learned from user interactions with the system 500 through various computer-learning methods, as discussed elsewhere herein. Non-limiting examples of user attributes include an e-mail address, IP address, demographics data, spending potential, gender, whether a user is a consumer or a business, location data, user id, rewards account number, products of interest or potentially of interest to the user, product purchase history, devices registered to the user, age, ethnicity, marital status, etc. In a further example, the user profile data 644 may include a user classification scheme and may classify user's based on attributes. The classifications to which a given user is classified into may be stored in the user's profile data 644 as attributes describing that user.

The user profile data 644 may be correlated with other data in the data storage 614, such as the web analytics data 640, product data 642, ranking data 648, scoring data 650, etc.

The pricing data 646 may include data pertaining to pricing of a particular product or class of products and correlation to other data in the data storage 614 (e.g., the product data 642, the user profile data 644, etc.). In some implementations, the pricing data 646 includes a history of past offers, retail prices (e.g., MSRP), discounts, average sale prices on one or more competitive websites, profit margins, wholesale product costs, etc.

The ranking data 648 may include data pertaining to a user's preference for one or more products on the online application. In some implementations, the ranking data 648 includes highest selling products for a class of users, a popular product category/class for top purchasing users, etc. In some implementations, the inference engine 526 receives interaction data from the server 522 and/or third-party server 516 for determining the user's preference for one or more products based on the received interaction data. In some implementations, the inference engine 526 uses the ranking data for determining a top most similar product classes based on ranked similarity scores of users.

The scoring data 650 may include data pertaining to scoring a user's preference for one or more products or class of products using several dimensions associated with the user's behavior on the online application. In some implementations, the inference engine 526 determines a customer's preference score for a given product or product class as a function of one or more customer interactions. In some implementations, the interference engine 526 uses the scoring data 650 to determine a customer target size for a marketing campaign associated with one or more products on the online application.

The data storage 614 may be included in the computing system 600 or in another computing system and/or storage system distinct from but coupled to or accessible by the computing system 600. The data storage 614 may include one or more non-transitory computer-readable mediums for storing the data. In some implementations, the data storage 614 may be incorporated with the memory(ies) 604 or may be distinct therefrom. In some implementations, the data storage 614 stores data associated with a database management system (DBMS) operable on the computing system 600. For example, the DBMS may include a structured query language (SQL) DBMS, a NoSQL DMBS, various combinations thereof, etc. In some instances, the DBMS stores data in multi-dimensional tables comprised of rows and columns, and manipulate, e.g., insert, query, update and/or delete, rows of data using programmatic operations.

The various types of data 640, 642, 644, 646, 648, and 650 stored in the data storage 614, as described elsewhere herein, may be combined, further delineated, linked, and associated, etc. They may be retrievable and/or searchable, for example, using a unique identifier, keywords, and/or other search terms. The various components of the system 500, including for example, those discussed in reference to FIG. 5, and more particularly the inference engine 526 may access (e.g., store, create, retrieve, modify, read, delete, etc.) data stored therein to facilitate the operations of the components. Non-limiting examples of these types of data, as well as methods to access data, by the various components of the system 500, are disclosed herein, but it should be understood that other types of data and access methods are possible and contemplated.

FIG. 7 depicts a flowchart of an example method for determining similar class(es). In block 702, the inference engine 526 determines a product group selectively grouping one or more of related products and related product classes. For instance, the inference engine 526 may characterize an existing buyer by analyzing interaction data describing the level of that customer's activity using one or more specific dimensions, as depicted in FIG. 1. In some implementations, the inference engine 526 qualitatively determines, using the interaction data, customer preference values indicating preferences of the customers for one or more of the products of the product database and the product classes to which the products of the product database belong and determines a product group selectively grouping related product(s) and/or related product class(es) based on the interaction data customer preference values.

In some implementations, a product may include any product or service. The product may belong to one or more product and/or service classes. The classes can be organized hierarchically. An example well-defined product hierarchy may include, but are not limited to, the following: Class(es)→SKU Sets→Product→Departments→Divisions. In some implementations, an inference engine 526 selects a certain hierarchy level based on a target application.

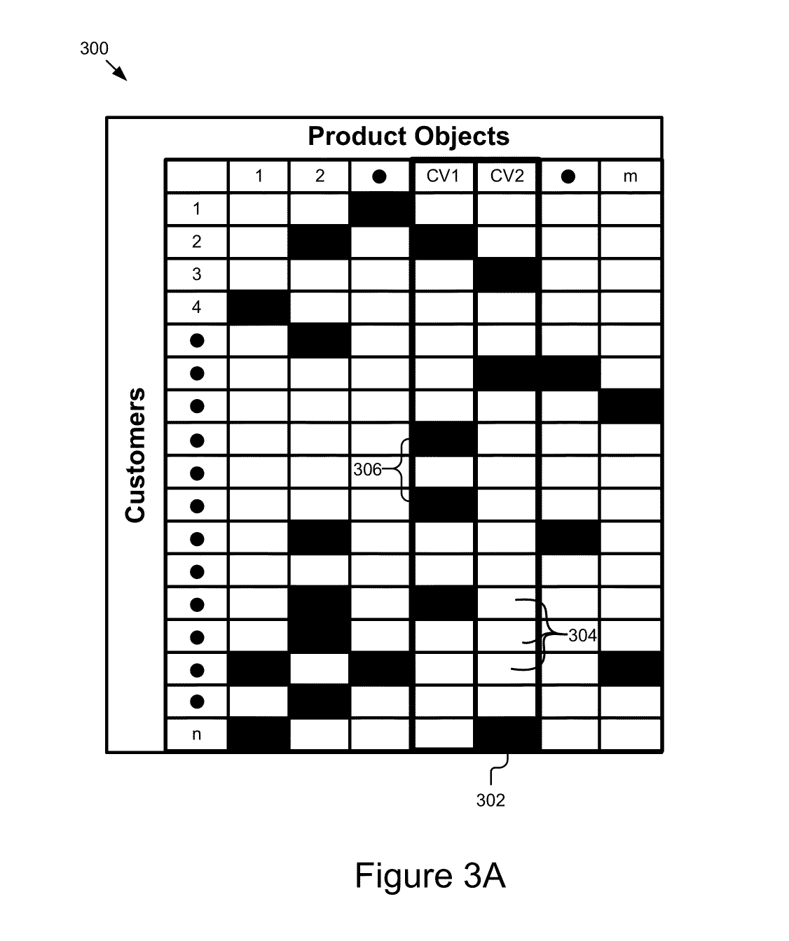

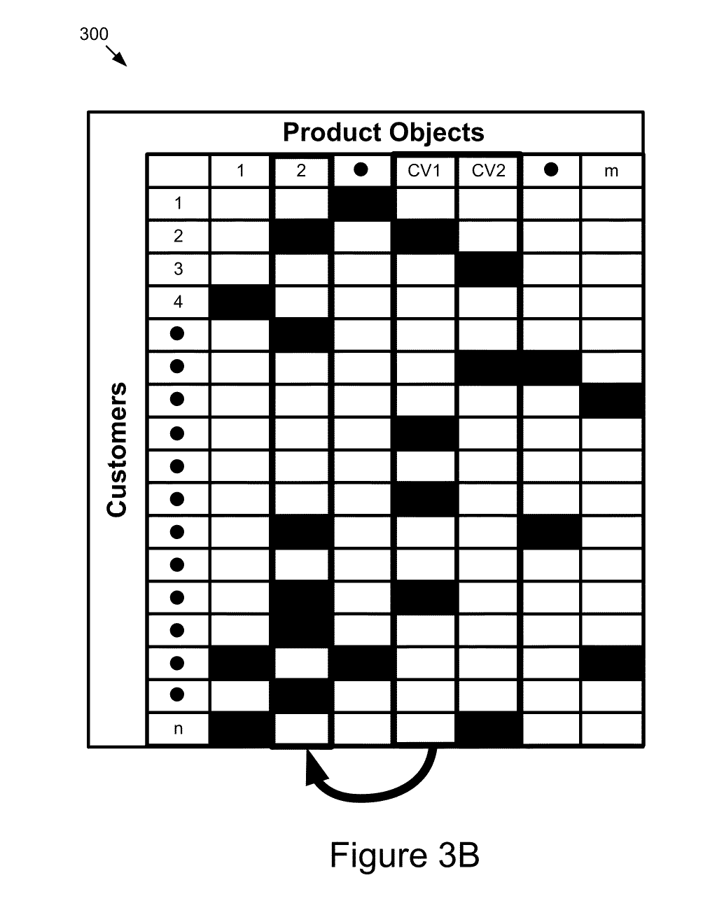

In block 704, the inference engine 526 may compute centroid values averaging customer preference values for the one or more of the related products and the related product classes of the product group. For instance, the inference engine 526 may compute centroid values of the customer preference values for the one or more of the related product and the related product classes of the product group associated with a product preference matrix, such as the example product preference matrix as depicted in FIG. 3A, as discussed further elsewhere herein. In some implementations, the inference engine 526 computes a customer-product preference matrix using the customer preference values for a product, product classifications, or groups of classifications, etc.

In block 706, the inference engine 526 may compute similarity scores between the product group and other product objects using the customer preference centroid values associated with the product group and customer preference values associated with the product objects. The product objects may include one or more of products and product classes from the product database. For instance, the inference engine 526 may compute the similarity scores between the customers' customer preference centroids and additional product categories in a customer-product preference matrix using cosine similarity, as depicted in FIG. 3B and discussed elsewhere herein. The inference engine 526 may compute similarity scores between the product group and other product objects using a first set of entries and a second set of entries, as depicted in FIG. 3A and discussed elsewhere herein.

In block 708, the inference engine 526 may select for recommendation one of the other product objects based on the similarity scores.

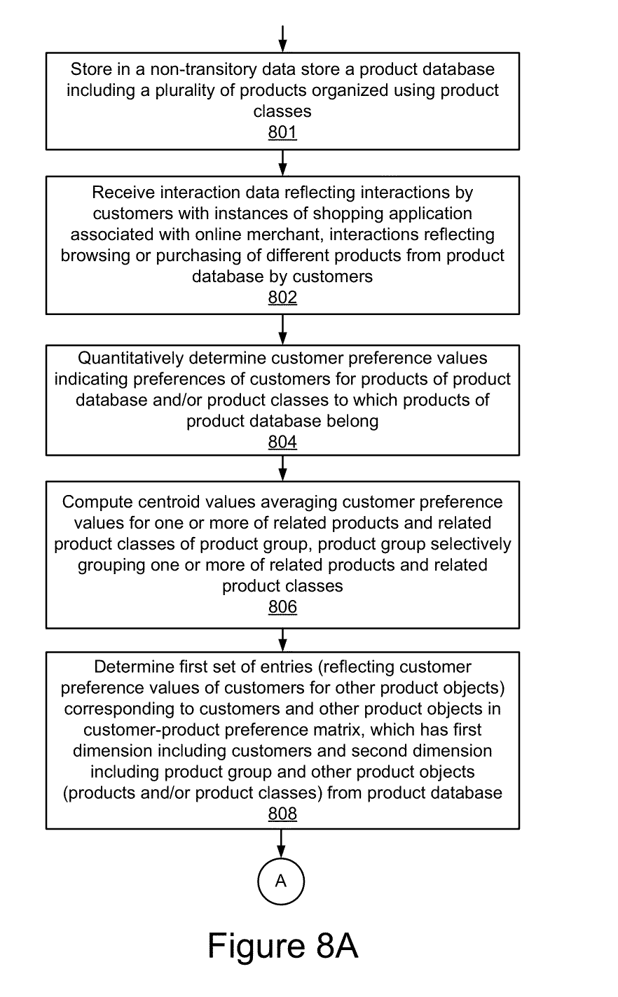

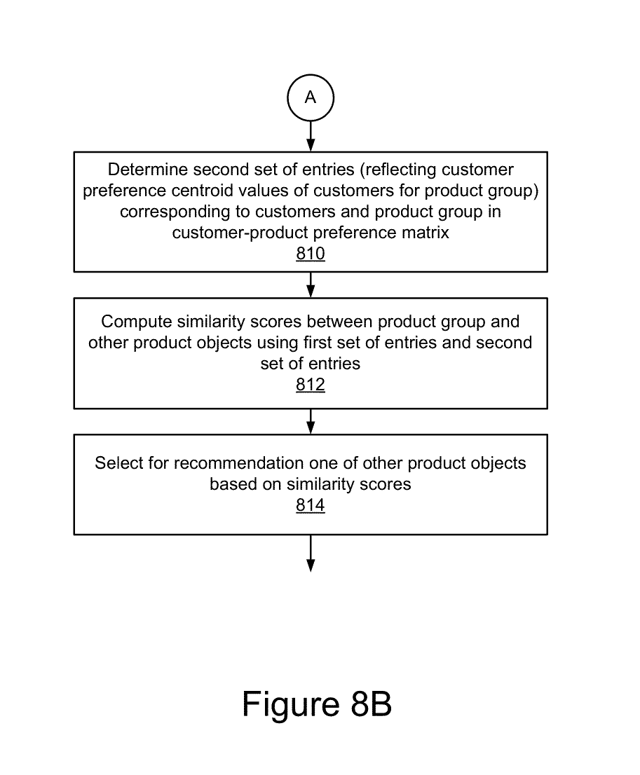

FIGS. 8A and 8B depict flowcharts of another example method for determining similar class(es).

In block 801, the inference engine 526 may store in a non-transitory data store a product database including a plurality of products organized using product classes.

In block 802, the inference engine 526 may receive interaction data reflecting interactions by customers with instances of a shopping application associated with an online merchant, the interactions reflecting browsing or purchasing of different products from the product database by the customers.

The following further example implementations are provided to further illustrate the operations of block 802. FIG. 1 depicts a diagram illustrating example customer-product interactions of customers with a product page describing a product. A customer-product interaction may include interaction of the customer with a product page of a computer application operable on the customer's client device. In some implementations, server 522 collects interaction of the customer with the product page of the computer applications and stores the interaction as interaction data in a data store, such as data store 614. An example application, such as the client application 508, may include a merchant website hosted by a server, such as the server 522. The client device 506, client application 508, and the server 522 are discussed in further detail with reference to at least FIGS. 5 and 6. Further examples, may include, a mobile application provided by a merchant for download and operation on the customer's client device 506 (e.g., an app downloaded from an app store).

The interaction data may include a set of dimensions (as shown in FIG. 1) reflecting different aspects of behavior by customers when browsing and purchasing the different products. The set of dimensions, may include, but is not limited to, number of visits by the customer, number of pages viewed, time spent on each page, product finding method(s) used by the customer, number of times the customer added items to a virtual cart, number of times the customer removed items from the virtual cart, which items were added and removed from the virtual cart, items the customer purchased, items returned by the customer, profit yielded from products purchased by the customer, and revenue yielded from products purchased by the customer.

By way of example and not limitation, in promotional campaigns targeting non-customers/incremental customers, the inference engine 526 may characterize a non-customer/incremental customer by analyzing interaction data describing that customer's activity using one or more specific dimensions (e.g. product views and time spent on page). These specific dimension(s) may be given a higher weight relative to other dimensions, such as product views, etc., which may be assigned relatively lower weights when the inference engine 526 computes the overall customer preference score for the customer. In some implementations, the specific dimensions may be the cart additions and purchases performed by the customer using the application on his/her client device(s). For example, customer acquisition from a product point of view, for instance, the product views and time spent on page dimensions are more determinative than the other dimensions and hence are assigned higher weights relative to the other dimensions, such as those discussed elsewhere herein.

By way of further example and not limitation, in an example evidence-based approach using prior marketing campaign data, the inference engine 526 can separate customers into two groups 1) responders, and 2) non-responders. Campaign data may include interaction data of customers aggregated during a particular advertising campaign promoting various products on a given merchant's virtual store. The interaction data may describe a level of customer activity with various product pages in certain dimensions, such as the specific dimensions discussed previously.

The inference engine 526 may apply specific weights for the specific dimensions based on the level of activity (the behavior of the responders or non-responders). For example, if analysis of interaction data of the responders indicates that product views are more indicative of a response than the time on page, then product views are assigned a higher weight than time on page.

The inference engine 526 can additionally or alternatively apply weights to one or more dimensions of a set of dimensions (e.g. interaction dimensions). In some implementations, the weights can be variable weights and can be adjustable based on product and/or class(es) targeting preferences of a merchant. For example, a merchant's product targeting campaign may focus only on a sub-set (e.g. views, card additions, cart removals, purchases) of the set of dimensions and thus, apply higher weights (e.g. 1) to the sub-set of the set of dimensions and apply lower weights (e.g. 0) for the remainder dimensions in the set of dimensions.

The inference engine 526 can normalize the weighted dimensions of the set based on a predetermined scaling range, as depicted in FIG. 2. FIG. 2 is a graphical representation depicting graphs including results of two different example scoring methods. In some implementations, the inference engine 526 may modify the weighted dimensions based on one or more requirements, such as but not limited to the requirements of a targeting campaign. For instance, the predetermined ranges vary based on specific needs of a targeting exercise being performed by the inference engine 526 Additional examples of weighting elements are described below.

The inference engine 526 may normalize a given customer's interactions across different products to compute a relative dimensional preference of the customer for those products. The relative normalization may be performed using linear or sigmoidal normalization methods, such as those discussed above and in further detail below, although it should be understood that other suitable normalization methods may be used and are encompassed hereby. Non-limiting example dimensions that can be normalized include visits, viewed, time spent on page, product finding method, cart addition, cart removal, purchases, returns, etc.

FIG. 2 illustrates a non-limiting example based on the dimension of the number or product views of a given customer. In this example, the inference engine 526 normalizes a sample of 500 product views for a single product based on linear and sigmoidal scaling.

In particular, FIG. 2 depicts on the left hand side (LHS) a graph 202 plotting the product views vs. the linear normalized scores, and on the right hand side (RHS), FIG. 2 depicts a graph 204 plotting the product views vs. the sigmoidal normalized scores.

In some implementations, the inference engine 526 performs the linear normalization using a simple 0-1 scaling. For example, the inference engine 526 assigns a 0 for a minimum (Min) quantity of product views, and a 1 for a maximum (Max) quantity of product views, and each of the remaining quantities of product views take on values given by the following equation, referred to herein as Equation 1:

$${product}_{views} - \frac{min ( {product}_{views} )}{[ max ( {product}_{views} ) - min ( {product}_{views} ) ]} . \qquad ( Equation 1 )$$

In some implementations, the inference engine 526 performs the sigmoidal scaling using a similar scale of 0-1. The sigmoidal curve can be generated with location and scale parameters using the following equation, referred to herein as Equation 2:

$$y = \frac{1}{1 + exp ( - ( x - m ) / s )} \qquad ( Equation 2 )$$

where x indicates an independent variable, m indicates a location parameter, and s indicates a scaling parameter.

In some implementations, the inference engine 526 utilizes the location and scale parameters and adapts the curve being generated to the target application of the inference engine 526. The normalization performed by the inference engine 526, such as but not limited to linear or sigmoidal normalization, can be the same or vary for any of the behavioral dimensions.

As an example, in FIG. 2, the product views in the range 100-140 can be normalized to 0.63-1 using the linear method and 0.8-1 using sigmoidal method. The sigmoidal method may be applied to the dimensions to realize a more even distribution such that to avoid effects of high values (e.g. above 1) that skew the distribution and dominate the other values (e.g. below 1).

Returning to FIG. 8A, in block 804, the inference engine 526 may quantitatively determine using the interaction data the customer preference values, which indicate preferences of the customers for one or more of the products of the product database and the product classes to which the products of the product database belong. In some implementations, the inference engine 526 receives the interaction data from server 522 and/or third party server 516. The inference engine 526 may qualitatively determine customer preference values for the customers indicating the customers' preferences for the different product categories using the received interaction data.

A customer's preference, also referred to herein simply as a preference, means a customer's preference for a product or a product category. In some implementations, the inference engine 526 determines a customer's preference for a given product or product category as a function of one or more customer interactions. For instance, the customer's preference may be variably determined based on, but not limited to, one or more of the above-noted interaction dimensions (e.g. visits, views, time spent on a page, cart additions, cart removals, purchases, revenue, returns, etc.). In some implementations, the inference engine 526 may infer customer preference for a group of related classes for a particular initiative, such as a marketing campaign.

In some implementations, the inference engine 526 can compute customer preference values using the weighted dimensions and/or normalized weighted dimensions. For example, the inference engine 526 may use the following overall customer-preference score (OOPS) equation, referred to herein as Equation 3, to compute an overall customer-preference score:

OCPS=(W_{VS}×VisitScore)+(W_{VI}×ViewScore)+(W_{TM}×TimeScore)+(W_{CA}×CartAdditionScore)+(W_{CR}×CartRemovalScore)+(W_{PR}×PurchaseScore)+(W_{RS}×ReturnScore)+(W_{RV}×RevenueScore) (Equation.3)

where the Wₓₓ′s indicates the weights of the interactive dimensions, although it should be understood that other algorithms for computing OCPS are also possible and contemplated, such as a algorithms that include fewer and/or additional variables and/or different weights. In the above equation, W_{VS} is a weighting element associated with the visit score, W_{VI} is a weighting element associated with the view score, W_{TM} is a weighting element associated with the time score, W_{CA} is a weighting element associated with the cart addition score, W_{CR} is a weighting element associated with the cart removal score, W_{PR} is a weighting element associated with the purchase score, W_{RS} is a weighting element associated with the return score, and W_{RV} is a weighting element associated with the revenue score. In some implementations, the inference engine 526 may apply weighting elements (e.g. weights) to each dimension in the set of dimensions in Equation 3. In other implementations, the weighting elements may in some cases be assigned based on domain/expert knowledge and generated based on aggregated evidence (e.g., customer behavior).

As discussed above, the inference engine 526 can normalize the dimensions in Equation 3, such as using sigmoidal scaling, when the weighing elements are of extreme values and need to be limited.

In block 806, the inference engine 526 may compute centroid values averaging customer preference values for one or more of related products and related product classes of product group. In some implementations, the inference engine 526 selectively groups a product group into one or more of related products and related product classes. The inference engine 526 may compute for the customers a customer preference centroid using the determined customer preference values, as discussed elsewhere herein. The customer preference centroid may include averages of the customers' preferences for the categories of the product group. In some implementations, the inference engine 526 may compute a group centroid for a group of target classes.

For example, as depicted in FIG. 3A, CV1 and CV2 may include the customer preference scores reflecting a preference or a non-preference for the group of classes. Particularly, CV1 may represent a centroid of preference scores for a group, for example, education and CV2 may represent a centroid of preference scores for another group, for example, office. The application of a centroid for a group can be advantageous as it allows all target classes to be grouped to a single column in a customer-product preference matrix, as discussed elsewhere herein. In some implementations, the matrix may have a size of n×m, where n indicates the number of customers and m indicates the product classes. For example, the customer-product preference matrix may include a first dimension including customers and a second dimension including a product group and other product objects (products and/or product classes) from a product database.

In some implementations, the following equation, referred to herein as Equation 4, may be used by the inference engine 526 to compute the centroid of a given group.

$${C}_{p} = \frac{{\sum }_{i = 1}^{p} {S}_{i}}{p} \qquad ( Equation 4 )$$

where Cₚ indicates the centroid of p classes belonging to target group in n-dimensional customer space and Sᵢ indicates the preference score of a customer in class i.

In block 808, the inference engine 526 may determine a first set of entries corresponding to customers and other product objects in customer-product preference matrix. For example, the first set of entries may reflect the customer preference values of the customers for the other product objects where the customer-product preference matrix has a first dimension that includes the customers. A non-limiting example of such a matrix 300 is depicted in FIG. 3A. In this figure, classes are chosen reflecting a certain level of the product hierarchy. The classes are used by the inference engine 526 to compute customer preference scores.

The inference engine 526 may populate a first set of entries corresponding to the customers and the other product objects in the customer-product preference matrix where the first set of entries reflect the customer preference values of the customers for the other product objects. For example, in FIG. 3A, empty (white) cells (e.g., 304) in the matrix 300 imply no preference of a customer for a class exists and the shaded (black) cells (e.g., 306) indicate a customer preference for a class exists. In this example, the matrix is relatively sparse in nature, however in other configurations the matrix may include a non-sparse or semi-sparse matrix.

To further illustrate the concept of a group, a marketing group may wish to run specific marketing campaigns for a particular group of product classes, such as offer promotions on products belonging to the group “Education”. An example list of relevant classes in this group is shown in Table 1.

TABLE 1
Classes belonging to group - “Education”

| Class ID | Class Name |
|---|---|
| 820 | CRAYONS |
| 821 | CHILDREN'S MARKERS |
| 822 | CRAFT SUPPLIES |
| 823 | ART SUPPLIES |
| 824 | PAINT SUPPLIES |
| 825 | SCRAPBOOK |
| 826 | PENCIL POUCHES & BOXES |
| 827 | DRAFTING TOOLS & SUPPLIES |
| 829 | SCHOOL CONTRACT MISC. |
| 830 | STICKERS |
| 831 | CLASSROOM DECOR |
| 832 | GAMES & PUZZLES |
| 833 | TEACHING AIDS |
| 834 | TEACHING & EDUCATION BOOKS |
| 999 | CONTRACT PROPRIETARY PRINT |

In block 810, the inference engine 526 may determine a second set of entries corresponding to customers and product group in customer-product preference matrix. The second set of entries may reflect the customer preference centroid values of the customers for the product group.

In block 812, the inference engine 526 may compute similarity scores between product group and other product objects using first of entries and second set of entries. In some implementations, the inference engine 526 infers a similar product, class of products, or group of products using the customer-product-preference matrix. This inferring effectively allows the inference engine 526 to understand which additional products, class of products, or groups of classes may exhibit similar customer behavior to a given, product, class or target group, say CV1, for example.

In some implementations, the customer-product preference matrix may embody m class vectors of dimension n. Each vector may capture the behavioral preference of n customers. In vector space, the distance between CV1 and all other classes can be computed using a similarity computation.

For example, FIG. 3B depicts that for a similarity between CV1 and an adjacent column may be represented by similarity(2,Centroid−CV1). In some implementations, the similarity between columns in the customer-product preference matrix may be computed using cosine similarity, although other similarity computation measures like Pearson correlation, Spearman correlation, or Tanimoto coefficient based similarity methods, etc., can also be employed. An example equation, which is referred to herein as Equation 5, for computing cosine similarity is:

Sim(i,j)=cos(\vec{i},\vec{j})=\vec{i}·\vec{j}/(∥\vec{i}∥₂×∥\vec{j}∥₂) (Equation 5)

where i and j are two class vectors and the similarity between them can be computed as the cosine of the angle between and may range from −1 to 1.

In some implementations, the inference engine 526 stores the computed similarity scores in the data storage 614 as scoring data 650. In some implementations, the inference engine 526 selects one or more similar product categories based on the similarity scores.

In block 814, the inference engine 526 may select for recommendation one of other product objects based on the computed similarity scores.

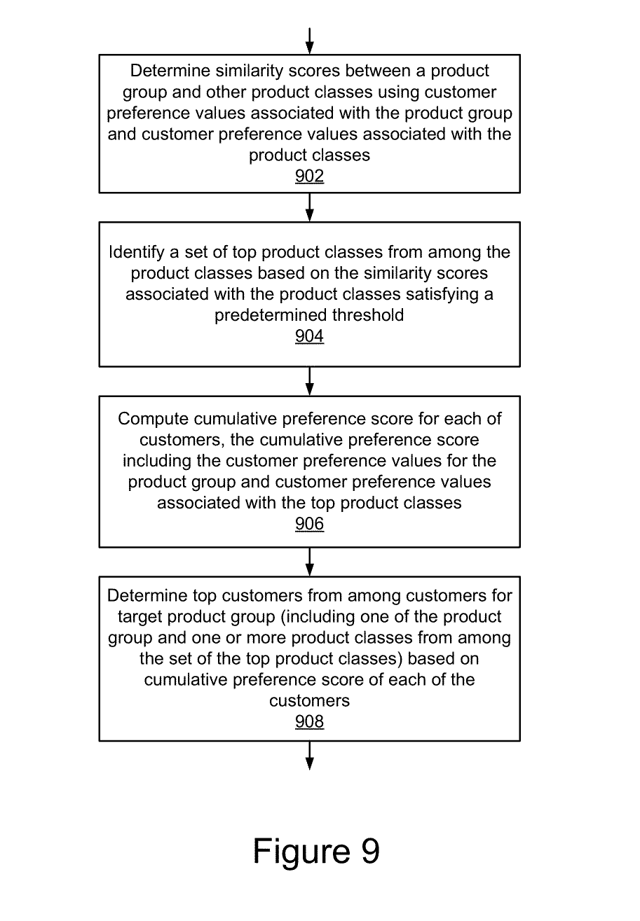

FIG. 9 depicts a flowchart of an example method for determining top customers/classes for targeting.

In block 902, the inference engine 526 may determine similarity scores between a product group and other product classes using customer preference values associated with the product group and customer preference values associated with the product classes.

In block 904, the inference engine 526 may identify a set of top product classes from among the product classes based on the similarity scores associated with the product classes satisfying a predetermined threshold. On the basis of similarity, the inference engine 526 may identify the top k most similar classes based on ranked similarity scores. In some implementations, the inference engine 526 identify a set of top product classes from among the product classes based on the similarity scores associated with the product classes satisfying a predetermined threshold.

For example, a total customer similarity score can be computed as the sum of the customer preference score for the group (base score) and scores for the top k classes. In some implementations, the inference engine 526 computes a cumulative preference score for each of the customers. For instance, the cumulative preference score may include the customer preference values for the product group and customer preference values associated with the top product classes.

In some implementations, the top k classes may exclude the individual classes that made up a custom group, although in further implementations these classes could be included. As an example, for class group “Education”, a customer's total score would be the sum of preference score for “Education” classes and the sum of preference scores for the top k similar classes, which are listed in Table 2.

TABLE 2
Classes similar to group - “Education”
Education Group - Top 20 similar classes

| Rank | Classes | Description |
|---|---|---|
| 1 | 942 | NOTEBOOKS |
| 2 | 794 | ADHESIVES |
| 3 | 730 | GRAPHITE PENCILS |
| 4 | 734 | ERASERS |
| 5 | 951 | POST IT |
| 6 | 735 | PENCIL SHARPENERS - MANUAL |
| 7 | 789 | SCISSORS |
| 8 | 750 | PERMANENT MARKERS |
| 9 | 941 | FILLER & MEMO PAPER |
| 10 | 781 | MEASURING INSTRUMENTS |
| 11 | 720 | BALL POINT STIC PENS |
| 12 | 970 | TOP TABBED FOLDERS |
| 13 | 814 | DESK ORGANIZERS & SORTERS |
| 14 | 753 | DRY ERASE PENS & MARKERS |
| 15 | 751 | HIGHLIGHTERS |
| 16 | 783 | STAPLERS - DESKTOP |
| 17 | 954 | INDEX CARDS |
| 18 | 940 | PADS |
| 19 | 514 | CUPS |
| 20 | 721 | BALL POINT RETRACTABLE PENS |

In block 906, the inference engine 526 may compute cumulative preference score for each of the customers where the cumulative preference score including the customer preference values for the product group and customer preference values associated with the top product classes.

In block 908, the inference engine 526 may determine top customers from among customers for target product group based on the cumulative preference score of each of the customers. For example, the cumulative preference score may include one of the product group and one or more product classes from among the set of the top product classes. In some implementations, the inference engine 526 ranks and segments customers. For instance, the inference engine 526 may rank customers based on their corresponding overall preference scores and may select the top r customers for targeting. The size of target customer base r may be determined based on the application and examination of model scoring.

In some implementations, the inference engine 526 determines a set of top customers from among the customers for a target product group based on the cumulative preference score of each of the customers. For instance, the target product group may include one of the product group and one or more product classes from among the set of the top product classes.

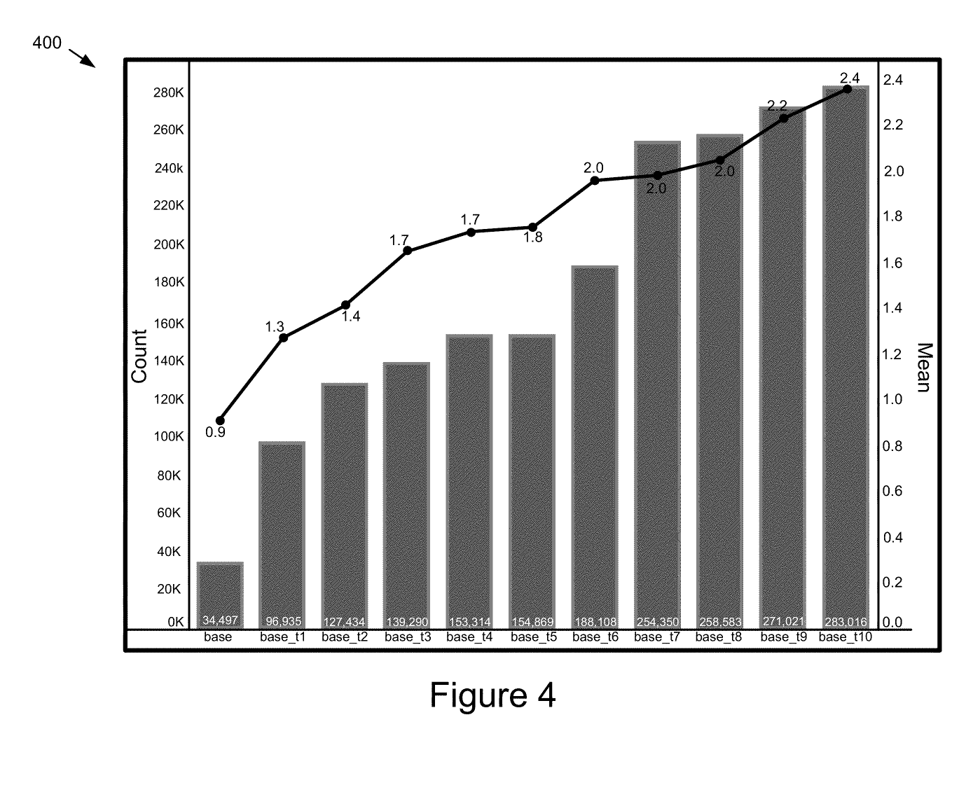

By way of further illustration, FIG. 4 is a graphical representation depicting a mean score and customer size for a base class and a combination of the base class and each of the top 10 similar classes. In an example, if an applicable marketing campaign has a budget for 400,000 customers, the base score and scores for three of the top classes can be used to select the customers. In a second example, the depicted data could be used to determine the customer size that should be targeted for the marketing campaign. For instance, considering the data in FIG. 4, a natural inflection point is reached at around a score of 1.7, beyond which there may be diminishing returns in terms of growth of targeted customers.

In some implementations, the inference engine 526 includes code implemented in the R programming language to produce at least in part the scoring, ranking, and statistical data discussed herein, although other suitable programming languages are also contemplated and encompassed by this disclose.

The following is a further non-limiting example of results produced by methods discussed herein. In particular, the methods were used to target customers showing interest in the education sector in an email campaign. The method advantageously delivered results that outperformed a current targeting model based on the following dimensions:
Open Rates: +50% increase
Click-thru Rate: +2.03× increase
Conversion Rate: +9.9× increase
Average Order Value, AOV: 23% increase
Revenue per Circ.: 12.5× increase
Unsubscribe Rate: +3.2% decrease

These above results illustrate a significant improvement over current techniques provided by the methods discussed herein, and can provide real business value, such as increases in revenue and profits, for merchants that utilize the method in their campaigns.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an implementation containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A computer-implemented method comprising:
receiving, using one or more computing devices, interaction data reflecting interactions by customers with instances of a shopping application associated with an online merchant, the interactions reflecting browsing or purchasing of different products from a product database by the customers;
quantitatively determining, using the one or more computing devices and the interaction data, customer preference values indicating preferences of the customers for one or more of the products of the product database and the product classes to which the products of the product database belong;
computing, using the one or more computing devices, centroid values averaging the customer preference values for the one or more of the related products and the related product classes of a product group, the product group selectively grouping one or more of related products and related product classes;
determining, using the one or more computing devices, a first set of entries corresponding to the customers and the other product objects in a customer-product preference matrix, the first set of entries reflecting the customer preference values of the customers for the other product objects, the customer-product preference matrix having a first dimension that includes the customers and a second dimension that includes the product group and other product objects including one or more of products and product classes from the product database;
determining, using the one or more computing devices, a second set of entries corresponding to the customers and the product group in the customer-product preference matrix, the second set of entries reflecting the customer preference centroid values of the customers for the product group;
computing, using the one or more computing devices, the similarity scores between the product group and the other product objects using the first set of entries and the second set of entries; and
selecting for recommendation, using the one or more computing devices, one of the other product objects based on the similarity scores.

2. A computer-implemented method comprising:
determining, using the one or more computing devices, a product group selectively grouping one or more of related products and related product classes;
computing, using the one or more computing devices, centroid values averaging customer preference values for the one or more of the related products and the related product classes of the product group;
computing, using the one or more computing devices, similarity scores between the product group and other product objects using the customer preference centroid values associated with the product group and customer preference values associated with the product objects, the product objects including one or more of products and product classes from the product database; and
selecting for recommendation, using the one or more computing devices, one of the other product objects based on the similarity scores.

3. The computer-implemented method of claim 2, wherein computing the similarity scores between the product group and the other product objects further comprises:
generating, using the one or more computing devices, a customer-product preference matrix having a first dimension that includes the customers and a second dimension that includes the product group and the other product objects;
populating, using the one or more computing devices, a first set of entries corresponding to the customers and the other product objects in the customer-product preference matrix, the first set of entries reflecting the customer preference values of the customers for the other product objects;
populating, using the one or more computing devices, a second set of entries corresponding to the customers and the product group in the customer-product preference matrix, the second set of entries reflecting the customer preference centroid values of the customers for the product group; and
computing, using the one or more computing devices, the similarity scores between the product group and the other product objects using the first set of entries and the second set of entries.

4. The computer-implemented method of claim 2, further comprising:
storing in a non-transitory data store a product database including a plurality of products organized using product classes;
receiving, using one or more computing devices, interaction data reflecting interactions by customers with instances of a shopping application associated with an online merchant, the interactions reflecting browsing or purchasing of different products from the product database by the customers; and
quantitatively determining, using the one or more computing devices and the interaction data, the customer preference values, which indicate preferences of the customers for one or more of the products of the product database and the product classes to which the products of the product database belong.

5. The computer-implemented method of claim 4, wherein the interaction data includes a set of dimensions reflecting different aspects of behavior by customers when browsing and purchasing the different products.

6. The computer-implemented method of claim 5, further comprising:
applying weights one or more dimensions of the set of dimensions; and
normalizing each of the weighted dimensions based on a predetermined scaling range, wherein qualitatively determining the customer preference values includes computing the customer preference values using the normalized weighted dimensions.

7. The computer-implemented method of claim 6, wherein the predetermined scaling range comprises one of a linear scaling and a sigmoidal scaling.

8. The computer-implemented method of claim 5, wherein the aspects include two or more of total visits to the shopping application by the customers, page view amounts for the different products, amounts of time spent on pages by the customers, products added to a virtual shopping cart of the shopping application, products removed from the virtual shopping cart of the shopping application, quantities or products ordered, unit prices of products ordered, and product returns.

9. A system comprising:
one or more processors;
one or more memories storing instructions that, when executed by the one or more processors, cause the system to:
determine a product group selectively grouping one or more of related products and related product classes;
compute centroid values averaging customer preference values for the one or more of the related products and the related product classes of the product group;
compute similarity scores between the product group and other product objects using the customer preference centroid values associated with the product group and customer preference values associated with the product objects, the product objects including one or more of products and product classes from the product database; and
select for recommendation one of the other product objects based on the similarity scores.

10. The system of claim 9, wherein to compute the similarity scores between the product group and the other product objects further comprises:
generating a customer-product preference matrix having a first dimension that includes the customers and a second dimension that includes the product group and the other product objects;
populating a first set of entries corresponding to the customers and the other product objects in the customer-product preference matrix, the first set of entries reflecting the customer preference values of the customers for the other product objects;
populating a second set of entries corresponding to the customers and the product group in the customer-product preference matrix, the second set of entries reflecting the customer preference centroid values of the customers for the product group; and
computing the similarity scores between the product group and the other product objects using the first set of entries and the second set of entries.

11. The system of claim 10, wherein the instructions, when executed by the one or more processors, further cause the system to:
store in a non-transitory data store a product database including a plurality of products organized using product classes;
receive interaction data reflecting interactions by customers with instances of a shopping application associated with an online merchant, the interactions reflecting browsing or purchasing of different products from the product database by the customers; and
quantitatively determine the customer preference values, which indicate preferences of the customers for one or more of the products of the product database and the product classes to which the products of the product database belong.

12. The system of claim 11, wherein the interaction data includes a set of dimensions reflecting different aspects of behavior by customers when browsing and purchasing the different products.

13. The system of claim 12, wherein the instructions, when executed by the one or more processors, further cause the system to:
apply weights one or more dimensions of the set of dimensions; and
normalize each of the weighted dimensions based on a predetermined scaling range, wherein qualitatively determining the customer preference values includes computing the customer preference values using the normalized weighted dimensions.

14. The system of claim 13, wherein the predetermined scaling range comprises one of a linear scaling and a sigmoidal scaling.

15. The system of claim 12, wherein the aspects include two or more of total visits to the shopping application by the customers, page view amounts for the different products, amounts of time spent on pages by the customers, products added to a virtual shopping cart of the shopping application, products removed from the virtual shopping cart of the shopping application, quantities or products ordered, unit prices of products ordered, and product returns.

16. A computer-implemented method comprising:
determining, using one or more computing devices, similarity scores between a product group and other product classes using customer preference values associated with the product group and customer preference values associated with the product classes, the product group selectively grouping one or more of related products and related product classes;
identifying, using the one or more computing devices, a set of top product classes from among the product classes based on the similarity scores associated with the product classes satisfying a predetermined threshold;
computing, using the one or more computing devices, a cumulative preference score for each of the customers, the cumulative preference score including the customer preference values for the product group and customer preference values associated with the top product classes; and
determining, using the one or more computing devices, a set of top customers from among the customers for a target product group based on the cumulative preference score of each of the customers, the target product group including one of the product group and one or more product classes from among the set of the top product classes.

17. A system comprising:
one or more processors;
one or more memories storing instructions that, when executed by the one or more processors, cause the system to:
determine similarity scores between a product group and other product classes using customer preference values associated with the product group and customer preference values associated with the product classes, the product group selectively grouping one or more of related products and related product classes;
identify a set of top product classes from among the product classes based on the similarity scores associated with the product classes satisfying a predetermined threshold;
compute a cumulative preference score for each of the customers, the cumulative preference score including the customer preference values for the product group and customer preference values associated with the top product classes; and
determine a set of top customers from among the customers for a target product group based on the cumulative preference score of each of the customers, the target product group including one of the product group and one or more product classes from among the set of the top product classes.
